(19) United States
(12) Patent Application Publication
(10) Pub. No.: US 2023/0144985 A1
(43) Pub. Date: May 11, 2023

(54) POSITIONING SYSTEM FOR WORK MACHINE, WORK MACHINE, AND POSITIONING METHOD FOR WORK MACHINE

(71) Applicant: Komatsu Ltd., Tokyo (JP)

(72) Inventors: Shunichiro Kondo, Tokyo (JP); Yuto Fujii, Tokyo (JP); Ken Tagami, Tokyo (JP)

(73) Assignee: Komatsu Ltd., Tokyo (JP)

(21) Appl. No.: 17/914,551

(22) PCT Filed: Apr. 14, 2021
(86) PCT No.: PCT/JP2021/015466

§ 371 Date: Sep. 26, 2022

(30) Foreign Application Priority Data
Apr. 17, 2020 (JP) 2020-074228

(51) Int. Cl. G01S 19/26; E02F 9/26; G01S 19/43; G01S 19/36

(52) U.S. Cl. CPC G01S 19/26; E02F 9/264; G01S 19/43; G01S 19/36; E02F 3/32

(57) ABSTRACT

There is provided a positioning system for a work machine using RTK positioning that uses a satellite positioning system, the positioning system including: a sensor controller that is a calculation unit that calculates a position of an antenna, of the satellite positioning system, disposed in the work machine based on a position of working equipment, of the work machine, aligned with a known reference point PR positioned at a work site; and a monitor controller that is an initialization control unit that outputs a control command that causes a receiver, of the satellite positioning system, that performs positioning calculation by the RTK positioning to execute initialization processing of the positioning calculation in which an integer value bias of each satellite and the position of the antenna of the satellite positioning system are unknown, by using the calculated position of the antenna of the satellite positioning system.

### FIELD

The present disclosure relates to a positioning system for a work machine, the work machine, and a positioning method for the work machine.

### BACKGROUND

Recently, information and communication technology (ICT) has been increasingly used in work machines such as excavators. For example, there is a work machine or the like on which global navigation satellite systems (GNSSs) or the like are mounted, and that detects a position of working equipment, compares positional information of the working equipment with current topographical data indicating a current topography of a work site, and obtains the position, a posture, or the like of the working equipment by performing arithmetic processing (for example, see Patent Literature 1).

### CITATION LIST

### Patent Literature

Patent Literature 1: JP 2014-205955 A

### SUMMARY

### Technical Problem

In a case where realtime kinematic (RTK) positioning (hereinafter referred to as “RTK positioning”) that uses the GNSS is performed in a work machine, it is necessary to perform initialization processing. However, in a case where a distance between a fixed station and a mobile station is long, a case where there is an obstacle around the mobile station, or the like, there may be a case where calculation for estimating and determining integer value bias of each satellite does not converge, and the initialization processing is not completed.

This disclosure has been made in view of the above, and an object of the present disclosure is to provide a positioning system for a work machine in which initialization processing can be appropriately executed in the RTK positioning that uses the GNSS, the work machine, and a positioning method for the work machine.

### Solution to Problem

According to an aspect of the present invention, a positioning system for a work machine using realtime kinematic positioning that uses a satellite positioning system, the positioning system comprises: a calculation unit that calculates a position of an antenna, of the satellite positioning system, disposed in the work machine based on a position of working equipment, of the work machine, aligned with a known reference point positioned at a work site; and an initialization control unit that outputs a control command that causes a receiver, of the satellite positioning system, that performs positioning calculation by the realtime kinematic positioning to execute initialization processing of the positioning calculation in which an integer value bias of each satellite and the position of the antenna of the satellite positioning system are unknown, by using the position of the antenna of the satellite positioning system that the calculation unit calculates.

### Advantageous Effect of Invention

According to an aspect of the present disclosure, initialization processing can be appropriately executed in the RTK positioning that uses the GNSS.

### BRIEF DESCRIPTION OF DRAWINGS

FIG. 1 is a perspective view illustrating a work machine according to an embodiment.

FIG. 2 is a view illustrating an operator's room of the work machine according to the embodiment.

FIG. 3 is a view for describing positioning of the work machine.

FIG. 4 is a schematic diagram illustrating a positioning system for the work machine according to the embodiment.

FIG. 5 is a block diagram illustrating an example of the positioning system for the work machine according to the embodiment.

FIG. 6 is a block diagram illustrating a computer system according to the embodiment.

FIG. 7 is a flowchart illustrating an example of a positioning method for the work machine according to the embodiment.

### DESCRIPTION OF EMBODIMENT

Hereinafter, an embodiment of a positioning system for a work machine, the work machine, and a positioning method for the work machine according to the present disclosure is described with reference to the drawings. Note that the present invention is not limited by the embodiment. In addition, constituent elements in the following embodiment include those that can be replaced and easily replaced by those skilled in the art or those that are substantially the same.

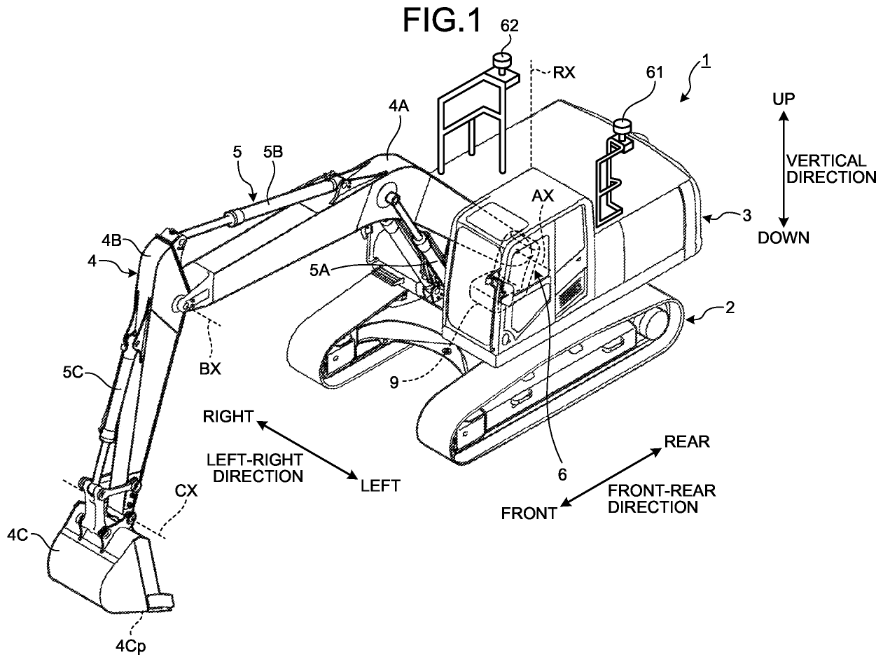

FIG. 1 is a perspective view illustrating a work machine 1 according to an embodiment. In the embodiment, the work machine 1 is an excavator. In the following description, the work machine 1 is referred to as an excavator 1. The excavator 1 includes a lower travel body 2, an upper swing body 3 supported by the lower travel body 2, working equipment 4 supported by the upper swing body 3, and a hydraulic cylinder 5 that drives the working equipment 4.

The lower travel body 2 can travel in a state where the lower travel body 2 supports the upper swing body 3. The lower travel body 2 includes a pair of crawler tracks. When the crawler tracks rotate, the lower travel body 2 travels.

The upper swing body 3 can swing about a swing axis RX with respect to the lower travel body 2 in a state where the upper swing body 3 is supported by the lower travel body 2. The upper swing body 3 includes an operator's room 6 where an operator of the excavator 1 gets in. An operator's seat 9 on which an operator sits is provided in the operator's room 6.

The working equipment 4 includes a boom 4A coupled to the upper swing body 3, an arm 4B coupled to the boom 4A, and a bucket 4C coupled to the arm 4B. The hydraulic cylinder 5 includes a boom cylinder 5A that drives the boom 4A, an arm cylinder 5B that drives the arm 4B, and a bucket cylinder 5C that drives the bucket 4C.

The boom 4A is supported by the upper swing body 3 so as to be rotatable about a boom rotation axis AX. The arm 4B is supported by the boom 4A so as to be rotatable about an arm rotation axis BX. The bucket 4C is supported by the arm 4B so as to be rotatable about a bucket rotation axis CX.

The boom rotation axis AX, the arm rotation axis BX, and the bucket rotation axis CX are parallel to each other. The boom rotation axis AX, the arm rotation axis BX, and the bucket rotation axis CX are orthogonal to axes parallel to the swing axis RX. In the following description, a direction parallel to the swing axis RX is referred to as a vertical direction, a direction parallel to the boom rotation axis AX, the arm rotation axis BX, and the bucket rotation axis CX is referred to as a left-right direction, and a direction orthogonal to both the boom rotation axis AX, the arm rotation axis BX, and the bucket rotation axis CX and the swing axis RX is referred to as a front-rear direction. With respect to an operator sitting on the operator's seat 9, a direction in which the working equipment 4 exists is a front side, and a direction opposite to the front side is a rear side. With respect to an operator sitting on the operator's seat 9, one side of the left-right direction is a right side, and a direction opposite to the right side is a left side. A direction away from a ground contact surface of the lower travel body 2 is an upper side, and a direction opposite to the upper side is a lower side.

The operator's room 6 is disposed on the front side of the upper swing body 3. The operator's room 6 is disposed on the left side of the working equipment 4. The boom 4A of the working equipment 4 is disposed on the right side of the operator's room 6.

[Operator's Room]

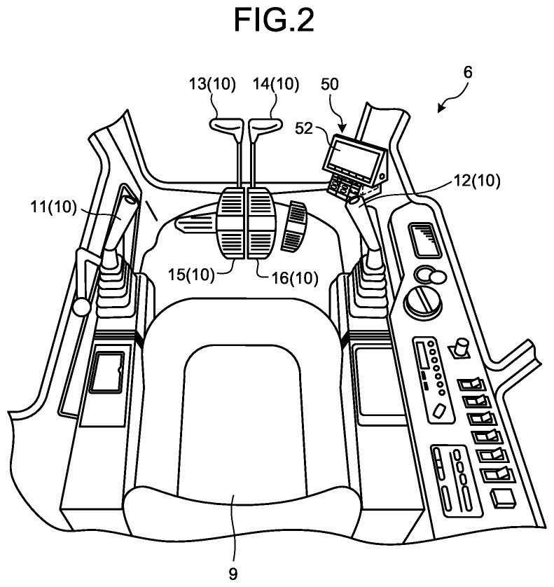

FIG. 2 is a view illustrating the operator's room 6 of the excavator 1 according to the embodiment. The excavator 1 includes an operation unit 10 disposed in the operator's room 6. The operation unit 10 is operated for actuating at least one portion of the excavator 1. The operation unit 10 is operated by an operator who is sitting on the operator's seat 9. The actuation of the excavator 1 includes at least one of the actuation of the lower travel body 2, the actuation of the upper swing body 3, and the actuation of the working equipment 4.

The operation unit 10 includes a left work lever 11 and a right work lever 12 that are operated for actuating the upper swing body 3 and the working equipment 4, a left travel lever 13 and a right travel lever 14 that are operated for actuating the lower travel body 2, and a left foot pedal 15 and a right foot pedal 16.

The left work lever 11 is disposed on the left side of the operator's seat 9. When the left work lever 11 is operated in the front-rear direction, the arm 4B performs a dumping movement or a drilling movement. When the left work lever 11 is operated in the left-right direction, the upper swing body 3 swings left or right. The right work lever 12 is disposed on the right side of the operator's seat 9. When the right work lever 12 is operated in the left-right direction, the bucket 4C performs the drilling movement or the dumping movement. When the right work lever 12 is operated in the front-rear direction, the boom 4A performs a descending movement or an ascending movement.

The left travel lever 13 and the right travel lever 14 are disposed on the front side of the operator's seat 9. The left travel lever 13 is disposed on the left side of the right travel lever 14. When the left travel lever 13 is operated in the front-rear direction, the crawler track on the left side of the lower travel body 2 performs a forward movement or a backward movement. When the right travel lever 14 is operated in the front-rear direction, the crawler track on the right side of the lower travel body 2 performs the forward movement or the backward movement.

The left foot pedal 15 and the right foot pedal 16 are disposed on the front side of the operator's seat 9. The left foot pedal 15 is disposed on the left side of the right foot pedal 16. The left foot pedal 15 is interlocked with the left travel lever 13. The right foot pedal 16 is interlocked with the right travel lever 14. When the left foot pedal 15 and the right foot pedal 16 are operated, the lower travel body 2 may perform the forward movement or the backward movement.

[Positioning System]

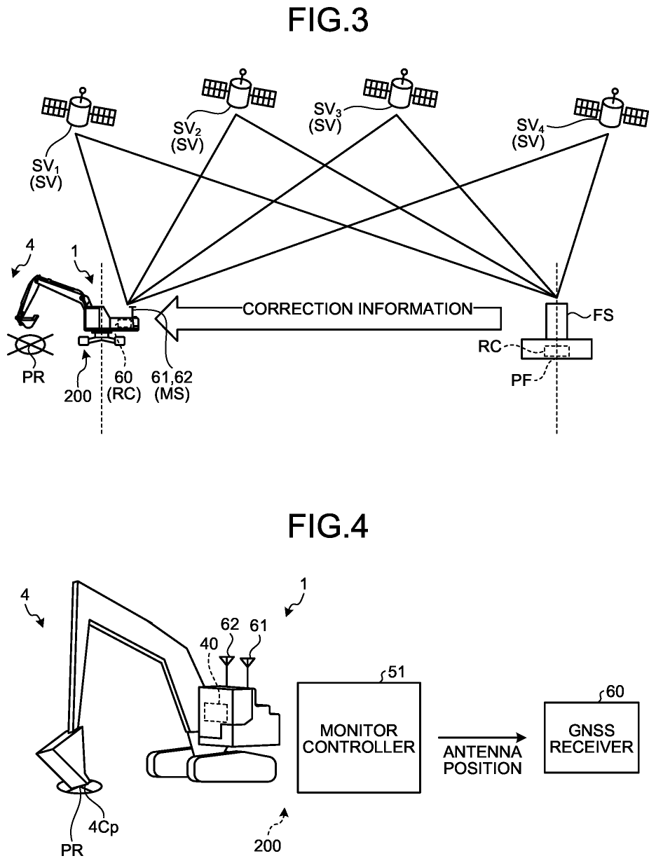

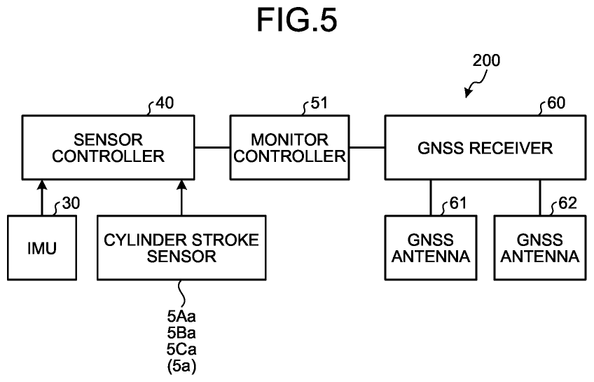

FIG. 3 is a view for describing positioning of the excavator 1. FIG. 4 is a schematic diagram illustrating a positioning system 200 for the excavator 1 according to the embodiment. FIG. 5 is a block diagram illustrating an example of the positioning system 200 for the excavator 1 according to the embodiment. The positioning system 200 positions a position of the excavator 1 by using RTK positioning that uses a GNSS that is a satellite positioning system.

As illustrated in FIG. 3, the RTK positioning is a method in which GNSS receivers RC, which are receivers of the satellite positioning system and are respectively mounted on a fixed station FS installed at a known point PF and a mobile station MS that moves, measure carrier phases that a plurality of GNSS satellites SV transmit, and determine a position of the mobile station MS. FIG. 3 illustrates a GNSS satellite SV₁, a GNSS satellite SV₂, a GNSS satellite SV₃, and a GNSS satellite SV₄.

The carrier phase is obtained by adding up an amount of variation in a distance between each GNSS satellite SV and the GNSS receiver RC. How many wave numbers (referred to as “integer value bias” or “ambiguity”) are included between each GNSS satellite SV and the GNSS receiver RC is unknown in a case where the GNSS receiver RC is in an initial state (immediately after activation). Therefore, the GNSS receiver RC mounted on the mobile station MS determines a highly accurate position of the mobile station and the integer value bias of each GNSS satellite SV by searching for (referred to as convergence calculation) the position of the mobile station where an error in distance from each satellite is minimized as initialization processing.

Positional information that the GNSS receiver RC receives is corrected by using correction information from the fixed station FS to obtain the position of the mobile station. However, in a case where the distance between the fixed station FS and the mobile station MS is long, correction effect by the correction information deteriorates, and an error in position that the GNSS receiver RC measures increases. As the error increases, it is difficult for the GNSS receiver RC during initialization processing to search for the position, so that there may be a case where the highly accurate position of the mobile station MS cannot be obtained, and the initialization processing is not completed.

Therefore, the positioning system 200 first calculates the position of the mobile station MS by a method other than the RTK positioning. Then, in the positioning system 200, the GNSS receiver RC mounted on the mobile station MS performs the initialization processing based on the position of the calculated mobile station MS. Accordingly, unknown variables are reduced, and the calculation of the integer value bias is likely to converge. In the embodiment, the positioning system 200 calculates a position of a GNSS antenna 61 that is an antenna, of the satellite positioning system, disposed in the excavator 1 based on a position of a blade edge 4Cp, of the working equipment 4 of the excavator 1, aligned with a known reference point PR positioned at a work site. The positioning system 200 outputs a control command that causes a GNSS receiver 60 that performs positioning calculation by the RTK positioning to execute initialization processing of the positioning calculation in which the integer value bias of each GNSS satellite and the position of the GNSS antenna 61 are unknown by using the calculated position of the GNSS antenna 61.

The positioning system 200 includes a cylinder stroke sensor 5a that detects a stroke length of each cylinder of the working equipment 4, an inertial measurement unit (IMU) 30, a sensor controller (calculation unit) 40, a monitor controller (initialization control unit) 51 of a monitor 50, the GNSS receiver 60, and GNSS antennas 61 and 62. The GNSS antenna 61 is used to obtain the position of the excavator 1, and the GNSS antenna 62 is used to obtain a yaw angle that is an azimuth angle of a vehicle body of the excavator 1.

The cylinder stroke sensor 5a detects information representing a posture of the working equipment 4. The cylinder stroke sensor 5a includes a boom cylinder sensor 5Aa, an arm cylinder sensor 5Ba, and a bucket cylinder sensor 5Ca. The boom cylinder sensor 5Aa, the arm cylinder sensor 5Ba, and the bucket cylinder sensor 5Ca are disposed in the working equipment 4. The boom cylinder sensor 5Aa detects boom cylinder length data indicating a stroke length that is a moving amount of the boom cylinder 5A. The arm cylinder sensor 5Ba detects arm cylinder length data indicating a stroke length that is a moving amount of the arm cylinder sensor 5Ba. The bucket cylinder sensor 5Ca detects bucket cylinder length data indicating a stroke length that is a moving amount of the bucket cylinder 5C. The cylinder stroke sensor 5a outputs each detected cylinder length data to the sensor controller 40.

The IMU 30 is a state detection device that detects movement information indicating the movement of the excavator 1. Note that the antennas 61 and 62 are also examples of the state detection device. In the embodiment, the movement information may include information indicating a posture of the excavator 1. As the information indicating the posture of the excavator 1, a roll angle, a pitch angle, and a yaw angle of the excavator 1 are exemplified. The IMU 30 is attached to the upper swing body 3. The IMU 30 may be, for example, installed in a lower portion of the operator's room 6.

The IMU 30 detects angular velocity and acceleration of the excavator 1. With the movement of the excavator 1, various types of acceleration, such as acceleration generated during traveling, angular acceleration generated during swinging, and gravitational acceleration, are generated in the excavator 1, and the IMU 30 detects and outputs at least the gravitational acceleration. Here, the gravitational acceleration is acceleration corresponding to a resisting force against gravity. The IMU 30 detects, for example, in a three-dimensional global coordinate system (X, Y, Z), acceleration in an X axis direction, a Y axis direction, and a Z axis direction, and angular velocity (rotation angular velocity) around an X axis, a Y axis, and a Z axis.

The global coordinate system is a coordinate system in which an origin fixed on the earth is set as a reference. The global coordinate system is defined by the GNSS.

The sensor controller 40 includes a processing unit that is a processor such as a central processing unit (CPU) and a storage unit that is a storage device such as a random access memory (RAM) and a read only memory (ROM). Detection values of the IMU 30 and detection values of the boom cylinder sensor 5Aa, the arm cylinder sensor 5Ba, and the bucket cylinder sensor 5Ca are input to the sensor controller 40. The position of the excavator 1 in the global coordinates that the GNSS receiver 60 obtains is input to the sensor controller 40 via the monitor controller 51. The sensor controller 40 functions as a calculation unit.

After completion of the initialization processing of the GNSS receiver 60, the sensor controller 40 generates a target blade edge position data indicating a target blade edge position based on blade edge position data of the excavator 1 and current topographical data indicating a current topography of the work site. The blade edge position data is data indicating a current position of the blade edge 4Cp of the excavator 1. The blade edge position data is generated based on the position of the excavator 1 in the global coordinates, the detection values of the cylinder stroke sensor 5a, and the detection values of the IMU 30. For example, the current topography indicated by the current topographical data is offset downward by a predetermined distance to generate a virtual target ground surface, and the target blade edge position data is generated such that the blade edge 4Cp conforms to the virtual target ground surface. The sensor controller 40 generates and outputs a working equipment command value that controls the movement of the working equipment 4 based on the blade edge position data and the target blade edge position data.

The sensor controller 40 calculates the position of the GNSS antenna 61 disposed in the work machine 1 based on the position of the blade edge 4Cp of the working equipment 4 aligned with the known reference point PR positioned at the work site. The sensor controller 40 converts the position of the GNSS antenna 61 of the excavator 1 obtained in the vehicle body coordinate system into the global coordinate system, and outputs it to the monitor controller 51 of the monitor 50.

The sensor controller 40 may calculate the position of the GNSS antenna 61 based on the position of the known reference point PR and an angle representing the posture of the working equipment 4 in a state where the blade edge 4Cp of the working equipment 4 is aligned with the reference point PR. More specifically, the sensor controller 40 obtains the position of the GNSS antenna 61 of the excavator 1 in the vehicle body coordinate system (Xm, Ym, and Zm) based on the position of the reference point PR measured in a three-dimensional site coordinate system and the detection values of the cylinder stroke sensor 5a detected in a state where the blade edge 4Cp of the working equipment 4 is aligned with the reference point PR.

Information representing the posture of the working equipment 4 is acquired from the moving amount of the boom cylinder 5A indicated by the detection value of the boom cylinder sensor 5Aa, the moving amount of the arm cylinder 5B indicated by the detection value of the arm cylinder sensor 5Ba, and the moving amount of the bucket cylinder 5C indicated by the detection value of the bucket cylinder sensor 5Ca. The information representing the posture of the working equipment 4 is defined by, for example, an angle θ1 formed by the boom 4A and the upper swing body 3, an angle θ2 formed by the boom 4A and the arm 4B, and an angle θ3 formed by the arm 4B and the bucket 4C.

The sensor controller 40 may calculate the position of the GNSS antenna 61 also based on posture angles that include the roll angle, the pitch angle, and the yaw angle of the excavator 1. More specifically, the sensor controller 40 obtains the position of the GNSS antenna 61 of the excavator 1 in the vehicle body coordinate system also based on the detection values of the IMU 30 detected in a state where the blade edge 4Cp of the working equipment 4 is aligned with the reference point PR.

The posture angles (the roll angle and the pitch angle) of the excavator 1 are acquired from the angular velocity and the acceleration, of the excavator 1, that are the detection values of the IMU 30. The yaw angle is acquired from the monitor controller 51.

The monitor 50 displays prescribed display data. The monitor 50 includes the monitor controller 51 and a display unit 52. Note that the display unit 52 may be a separate body. The monitor controller 51 includes a processing unit that is a processor such as a CPU and a storage unit that is a storage device such as a RAM and a read only memory (ROM). The monitor controller 51 functions as an initialization control unit. The monitor controller 51 outputs a control command that causes the GNSS receiver 60 that performs positioning calculation by the RTK positioning to execute initialization processing of the positioning calculation in which the integer value bias of each GNSS satellite and the position of the GNSS antenna 61 are unknown by using the position of the GNSS antenna 61 that the sensor controller 40 calculates. The monitor controller 51 outputs, to the GNSS receiver 60, the position of the GNSS antenna 61 of the excavator 1 acquired from the sensor controller 40 and converted into the global coordinate system.

The monitor controller 51 obtains the yaw angle that is an azimuth angle of the vehicle body from the antenna azimuth angle that the GNSS receiver 60 obtains and an arrangement relationship of the GNSS antennas 61 and 62 on the vehicle body. In addition, the obtained yaw angle is output to the sensor controller 40.

The display unit 52 includes a flat panel display such as a liquid crystal display (LCD) or an organic electroluminescence display (OELD). The display unit 52 can display progress status of the initialization processing of the GNSS receiver 60, such as that the initialization processing of the GNSS receiver 60 is being executed and that the initialization processing has ended. The monitor 50 is connected to the sensor controller 40 and the GNSS receiver 60 so as to be able to communicate data.

The GNSS receiver 60 functions as a global coordinate arithmetic unit. The GNSS receiver 60 includes a processing unit that is a processor such as a CPU and a storage unit that is a storage device such as a RAM and a ROM. The GNSS receiver 60 is a position detection device that detects a current position of the excavator 1 by using the GNSS. The GNSS receiver 60 obtains the position of the GNSS antenna 61, illustrated in FIG. 1, in the global coordinate system based on a signal corresponding to a GNSS radio wave that the GNSS antenna 61 receives. A global positioning system (GPS) is named as an example of the GNSS, but the GNSS is not limited thereto. The GNSS antenna 61 is installed in the excavator 1, for example.

The GNSS antenna 61 is disposed on the upper swing body 3. The GNSS antenna 61 is used to detect the current position of the excavator 1. The GNSS antenna 61 is connected to the GNSS receiver 60. The signal corresponding to the GNSS radio wave that the GNSS antenna 61 receives is input to the GNSS receiver 60.

In the initialization processing, the GNSS receiver 60 estimates and determines the integer value bias of each GNSS satellite by convergence calculation, and obtains a highly accurate position of the GNSS antenna 61 that is a mobile station. When executing the initialization processing, the GNSS receiver 60 acquires the position of the GNSS antenna 61 represented in the global coordinate system acquired from the monitor controller 51 of the monitor 50. The GNSS receiver 60 estimates and determines the integer value bias of each GNSS satellite by convergence calculation by using the position of the GNSS antenna 61 represented in the global coordinate system.

After completion of the initialization processing, the GNSS receiver 60 outputs the generated position of the GNSS antenna 61 to the monitor controller 51 of the monitor 50.

The GNSS receiver 60 calculates an azimuth angle by baseline analysis from satellite signals that positions of the GNSS antennas 61 and 62 receive, and the azimuth angle is set to an antenna azimuth angle of the GNSS antenna 62 in which the GNSS antenna 61 serves as an axis. In addition, the GNSS receiver 60 outputs the calculated antenna azimuth angle to the monitor controller 51.

[Computer System]

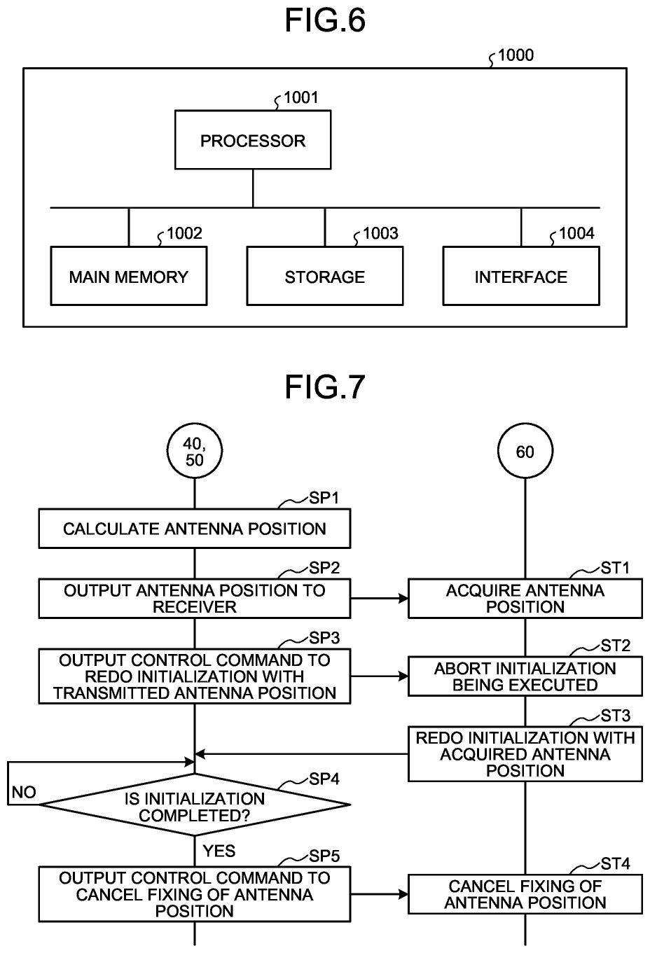

FIG. 6 is a block diagram illustrating a computer system 1000 according to the embodiment. The above-described positioning system 200 includes the computer system 1000. The computer system 1000 includes a processor 1001 such as a central processing unit (CPU), a main memory 1002 that includes a nonvolatile memory such as a read only memory (ROM) and a volatile memory such as a random access memory (RAM), a storage 1003, and an interface 1004 that includes an input output circuit. The functions of the positioning system 200 described above are stored in the storage 1003 as a computer program. The processor 1001 reads the computer program from the storage 1003, develops the computer program in the main memory 1002, and executes the above-described processing in accordance with the computer program. Note that the computer program may be distributed to the computer system 1000 via a network.

According to the above-described embodiment, the computer program or the computer system 1000 can make it possible to execute: aligning the blade edge 4Cp of the working equipment 4 with the known reference point PR measured at a work site; calculating the position of the GNSS antenna 61 disposed in the work machine 1 from the position of the reference point with which the blade edge 4Cp of the working equipment 4 is aligned; and outputting the control command that causes the GNSS receiver 60 that performs positioning calculation by the realtime kinematic positioning to execute initialization processing of the positioning calculation in which the integer value bias of each GNSS satellite and the position of the GNSS antenna 61 are unknown by using the position of the calculated GNSS antenna 61.

FIG. 7 is a flowchart illustrating an example of a positioning method for the excavator 1 according to the embodiment. At the work site, the reference point PR is measured in the three-dimensional site coordinate system, and the position is known. When the excavator 1 is activated, the initialization processing of the GNSS receiver 60 is executed. The monitor 50 can display the progress status of the initialization processing, such as that the initialization processing of the GNSS receiver 60 is being executed and that the initialization processing has ended. In a case where the initialization processing of the GNSS receiver 60 is not completed, for example, the processing illustrated in FIG. 7 is executed by an operation of an operator. First, an operator operates the working equipment 4 to align the blade edge 4Cp of the working equipment 4 with the reference point PR measured at the work site.

The positioning system 200 executes the processing from Step SP1 to Step SP5 in the sensor controller 40 and the monitor controller 51 of the monitor 50. In addition, Step ST1 to Step ST4 are executed in the GNSS receiver 60.

The sensor controller 40 calculates the position of the GNSS antenna 61 (Step SP1). More specifically, the sensor controller 40 calculates the position of the GNSS antenna 61 of the excavator 1 in the vehicle body coordinate system based on the position of the known reference point PR, and at least one of the detection values of the cylinder stroke sensor 5a and the detection values of the IMU 30 detected in a state where the blade edge 4Cp of the working equipment 4 is aligned with the reference point PR. The sensor controller 40 outputs the calculated position of the GNSS antenna 61 to the monitor controller 51.

The monitor controller 51 outputs the position of the GNSS antenna 61 acquired from the sensor controller 40 to the GNSS receiver 60 (Step SP2).

The GNSS receiver 60 acquires the position of the GNSS antenna 61 from the monitor controller 51 (Step ST1).

The monitor controller 51 outputs a control command to the GNSS receiver 60 to execute initialization processing in which the integer value bias of each GNSS satellite and the position of the GNSS antenna 61 are unknown by using the position of the GNSS antenna 61 that the sensor controller 40 calculates (Step SP3).

The GNSS receiver 60 interrupts the initialization processing being executed (Step ST2).

The GNSS receiver 60 redoes the initialization processing based on the acquired position of the GNSS antenna 61 (Step ST3).

The monitor controller 51 determines whether or not the initialization processing by the GNSS receiver 60 is completed (Step SP4). In a case where it is determined that the initialization processing by the GNSS receiver 60 is completed (Yes in Step SP4), the processing advances to Step SP5. In a case where it is not determined that the initialization processing by the GNSS receiver 60 is completed (No in Step SP4), the processing in Step SP4 is executed again.

The monitor controller 51 outputs a control command to the GNSS receiver 60 to cancel the fixed mode of the position of the GNSS antenna 61 (Step SP5).

The GNSS receiver 60 cancels the fixed mode of the position of the GNSS antenna 61 (Step ST4). During the initialization processing of the GNSS receiver 60, the fixed mode is set, and the processing is performed assuming that the position of the GNSS antenna 61 is fixed. While the fixed mode is set, the position of the excavator cannot be measured by the RTK positioning. By canceling the fixed mode, a highly accurate position of the excavator 1 that moves can be measured by the RTK positioning.

In this manner, at the time of the initialization processing of the GNSS receiver 60, unknown variables are reduced and the calculation of the integer value bias is likely to converge. Accordingly, the initialization processing of the GNSS receiver 60 is appropriately completed. Even when the excavator 1 moves after completion of the initialization processing of the GNSS receiver 60, a highly accurate position of the GNSS antenna 61 mounted in the excavator 1 can be obtained.

Note that the flowchart in FIG. 7 is an example, and not all steps need to be executed in other embodiments. For example, a case has been described, as an example, where the initialization processing of the GNSS receiver 60 is not completed, but the steps may be executed even in a case other than the case where the initialization processing of the GNSS receiver 60 is not completed. In this case, for example, Step ST2 and Step SP3 may not be executed.

### Advantageous Effects

As described above, in the embodiment, the GNSS receiver 60 that performs the positioning calculation by the RTK positioning is caused to execute the initialization processing of the positioning calculation based on the position of the GNSS antenna 61 calculated from the position of the known reference point PR. According to the embodiment, the GNSS receiver 60 can estimate and determine the integer value bias of each GNSS satellite by the convergence calculation by using the position of the GNSS antenna 61. According to the embodiment, it is possible to suppress the occurrence of a state where the initialization processing of the GNSS receiver 60 is not completed. In the embodiment, the initialization processing of the GNSS receiver 60 can be appropriately executed.

The embodiment has been described heretofore, but the embodiment is not limited by the contents described above. In addition, constituent elements described above include those that are easily conceived by those skilled in the art, those that are substantially the same, and those that are in a so-called equivalent range. Furthermore, the constituent elements described above can be appropriately combined. Furthermore, at least one of various omissions, substitutions, and modifications of the constituent elements can be performed without departing from the gist of the embodiment. For example, each processing described as what the sensor controller 40 executes may be executed by the monitor controller 51 of the monitor 50 or a controller other than these controllers. For example, each processing described as what the monitor controller 51 of the monitor 50 executes may be executed by the sensor controller 40 or a controller other than these controllers. For example, the functions of the sensor controller 40 and the monitor controller 51 of the monitor 50 may be implemented in one controller.

Work of aligning the blade edge 4Cp of the working equipment 4 with the known reference point PR performed in the embodiment is the work conventionally performed at the time of start of the work. In the embodiment, since an operator does not perform new work, it is possible to suppress an increase in the work load.

In addition, in the above embodiment, description has been made with the excavator 1 as an example of the work machine, but the embodiment is not limited thereto, and the work machine may be another work machine such as a bulldozer or a wheel loader.

In addition, in the above embodiment, description has been made in which the blade edge 4Cp of the working equipment 4 is aligned with the known reference point PR, but the embodiment is not limited thereto, and another portion of the working equipment 4 may be aligned with the known reference point PR.

In the above embodiment, description has been made in which the yaw angle is calculated by the monitor controller 51, but the yaw angle may be calculated by the sensor controller 40. Specifically, the monitor controller 51 outputs the antenna azimuth angle that the GNSS receiver 60 obtains to the sensor controller 40, and the sensor controller 40 may calculate the yaw angle from the antenna azimuth angle and the arrangement relationship of the GNSS antennas 61 and 62 on the vehicle body.

In the above embodiment, description has been made in which the GNSS antenna 61 is used to obtain the position of the excavator 1, but the embodiment is not limited thereto. For example, the GNSS antenna 62 may be used to obtain the position of the excavator 1. In this case, the GNSS antenna 61 may be used to obtain the yaw angle that is the azimuth angle of the vehicle body of the excavator 1. In addition, a GNSS antenna other than the GNSS antenna 61 and the GNSS antenna 62 may be provided, and the position of the excavator 1 may be obtained by using the GNSS antenna.

In the above embodiment, description has been made in which there are two GNSS antennas, but the embodiment is not limited thereto, and there may be one GNSS antenna. For example, in a case where the work machine is a bulldozer, the orientation of the vehicle body may be calculated from a velocity vector that the one GNSS antenna detects.

The working equipment of the above embodiment is an example, and can also be applied to working equipment of other work machines, such as blades of bulldozers and buckets of wheel loaders.

### REFERENCE SIGNS LIST

1 EXCAVATOR (WORK MACHINE)
2 LOWER TRAVEL BODY
3 UPPER SWING BODY
4 WORKING EQUIPMENT
4A BOOM
4B ARM
4C BUCKET
5 HYDRAULIC CYLINDER
5A BOOM CYLINDER
5Aa BOOM CYLINDER SENSOR
5B ARM CYLINDER
5Ba ARM CYLINDER SENSOR
5C BUCKET CYLINDER
5Ca BUCKET CYLINDER SENSOR
6 OPERATOR'S ROOM
9 OPERATOR'S SEAT
10 OPERATION UNIT
11 LEFT WORK LEVER
12 RIGHT WORK LEVER
13 LEFT TRAVEL LEVER
14 RIGHT TRAVEL LEVER
15 LEFT FOOT PEDAL
16 RIGHT FOOT PEDAL
30 IMU
40 SENSOR CONTROLLER (CALCULATION UNIT)
50 MONITOR
51 MONITOR CONTROLLER (INITIALIZATION CONTROL UNIT)
52 DISPLAY UNIT
60 GNSS RECEIVER (RECEIVER OF SATELLITE POSITIONING SYSTEM)
61 GNSS ANTENNA (ANTENNA OF SATELLITE POSITIONING SYSTEM)
62 GNSS ANTENNA (ANTENNA OF SATELLITE POSITIONING SYSTEM)
200 POSITIONING SYSTEM
1000 COMPUTER SYSTEM
1001 PROCESSOR
1002 MAIN MEMORY
1003 STORAGE
1004 INTERFACE
AX BOOM ROTATION AXIS
BX ARM ROTATION AXIS
CX BUCKET ROTATION AXIS
RX SWING AXIS

1. A positioning system for a work machine using realtime kinematic positioning that uses a satellite positioning system, the positioning system comprising:
a calculation unit that calculates a position of an antenna, of the satellite positioning system, disposed in the work machine based on a position of working equipment, of the work machine, aligned with a known reference point positioned at a work site; and
an initialization control unit that outputs a control command that causes a receiver, of the satellite positioning system, that performs positioning calculation by the realtime kinematic positioning to execute initialization processing of the positioning calculation in which an integer value bias of each satellite and the position of the antenna of the satellite positioning system are unknown, by using the position of the antenna of the satellite positioning system that the calculation unit calculates, wherein
the calculation unit calculates the position of the antenna of the satellite positioning system based on a position of the reference point and an angle representing a posture of the working equipment.

2. (canceled)

3. The positioning system for a work machine according to claim 1, wherein
the calculation unit calculates the position of the antenna of the satellite positioning system based on posture angles that include a roll angle, a pitch angle, and a yaw angle of the working equipment.

4. The positioning system for a work machine according to claim 1, wherein
the calculation unit calculates the position of the antenna of the satellite positioning system based on a position of a blade edge of the working equipment aligned with the reference point.

5. A work machine comprising:
a travel unit on which the working equipment is mounted and that travels; and
the positioning system for a work machine according to claim 1.

6. A positioning method for a work machine using realtime kinematic positioning that uses a satellite positioning system, the method comprising:
aligning a portion of working equipment with a known reference point measured at a work site;
calculating a position of an antenna, of the satellite positioning system, disposed in the work machine from a position of the reference point with which the portion of the working equipment is aligned; and
outputting a control command that causes a receiver, of the satellite positioning system, that performs positioning calculation by the realtime kinematic positioning to execute initialization processing of the positioning calculation in which an integer value bias of each satellite and the position of the antenna of the satellite positioning system are unknown, by using the calculated position of the antenna of the satellite positioning system, wherein
the calculating includes calculating the position of the antenna of the satellite positioning system based on a position of the reference point and an angle representing a posture of the working equipment.
